(19) United States
(12) Patent Application Publication
(10) Pub. No.: US 2010/0158357 A1
(43) Pub. Date: Jun. 24, 2010

(54) IMAGE PROCESSING METHOD AND SYSTEM OF SKIN COLOR ENHANCEMENT

(75) Inventors: SZEPO R. HUNG, Carlsbad, CA (US); XIAOYUN JIANG, San Diego, CA (US); HSIANG-TSUN LI, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/340,580

(22) Filed: Dec. 19, 2008

(51) Int. Cl. G06K 9/00

(52) U.S. Cl. 382/162

(57) ABSTRACT

Image processing methods and systems are disclosed. In a particular embodiment, a method is disclosed that includes receiving image data. The image data includes color component data representing a location of a pixel in a color space. The method further includes performing a linear transformation of the location of the pixel in the color space when the location is identified as within a skin color region of the color space. The linear transformation is performed by mapping the location of the pixel at a first portion of the skin color region to a second portion of the skin color region based on a position of the pixel within the skin color region and based on the proximity of the position of the pixel to a boundary of the skin color region. The color space remains substantially continuous at the boundary of the skin color region after applying the linear transformation.

### I. FIELD

The present disclosure is generally related to skin color enhancement systems and methods.

### II. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet Protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

Digital signal processors (DSPs), image processors, and other processing devices are frequently used in portable personal computing devices that include digital cameras or that display image or video data captured by a digital camera. Such processing devices can be utilized to provide video and audio functions, to process received data such as image data, or to perform other functions.

### III. SUMMARY

In a particular embodiment, a method is disclosed that includes receiving image data corresponding to an image. The image includes an image region having a skin tone color. The method also includes automatically processing the image data to modify a hue value and a saturation value in the image region having the skin tone color to generate modified image data that includes a modified hue value and a modified saturation value. The method further includes storing the modified image data in a memory.

In another particular embodiment, a method is disclosed that includes receiving image data, and the image data includes color component data representing a location of a pixel in a color space. The method further includes performing a linear transformation of the location of the pixel in the color space when the location is identified as within a skin color region of the color space. The linear transformation is performed by mapping the location of the pixel at a first portion of the skin color region to a second portion of the skin color region based on a position of the pixel within the skin color region and based on the proximity of the position of the pixel to a boundary of the skin color region. The color space remains substantially continuous at the boundary of the skin color region after applying the linear transformation.

In another particular embodiment, a method to adjust color in an image is disclosed. The method includes defining a first set of triangular regions that span a designated region of a color space. Each triangular region of the first set of triangular regions has a first edge along a boundary of the designated region and a vertex at a common point within the designated region. The method also includes defining a second set of triangular regions within the color space. Each triangular region of the second set of triangular regions has a vertex at a second common point. The second common point is translated with respect to the first common point. The method further includes receiving image data including color component data representing a location of a plurality of pixels in the color space. A portion of the plurality of pixels have color component data within the designated region. The method also includes determining, for each particular pixel having color component data within the designated region, a first triangular region of the first set of triangular regions that includes the particular pixel. The method further includes mapping a color space location of each particular pixel to a corresponding location within a second triangular region of the second set of triangular regions.

In another particular embodiment, a system is disclosed that includes a computer program stored on computer readable media to adjust a color of an image. The computer program has instructions that are executable to cause the computer to receive image data including color component data representing a pixel value in a chroma color space. The computer program further includes instructions that are executable to perform a linear transformation of a pixel associated with the pixel value when a location of the pixel is identified as within a skin color region of the chroma color space. The linear transformation is performed by mapping the location of the pixel at a first portion of the skin color region to a second portion of the skin color region based on a position of the pixel within the skin color region and based on a proximity of the position of the pixel to a boundary of the skin color region. The chroma color space remains substantially continuous at the boundary of the skin color region after applying the linear transformation.

In another particular embodiment, an apparatus is disclosed that includes an input to receive image data including color component data representing a location of a pixel in a chroma color space. The apparatus also includes an image processing path coupled to the input. The image processing path includes skin color adjustment circuitry configured to generate modified image data by performing a color space mapping of skin tones of an image to appear less yellow.

One particular advantage provided by disclosed embodiments is efficient color remapping of image data that can be performed on a wireless device.

### IV. BRIEF DESCRIPTION OF THE DRAWINGS

FIG. 1 is a block diagram of a particular illustrative embodiment of a system including an image processing system having a skin color adjustment module;

FIG. 2 is a diagram illustrating a linear transformation wherein a first set of triangular regions defines a skin tone region of a color space;

FIG. 3 is a diagram illustrating a linear transformation wherein a common vertex of the first set of triangular regions depicted in FIG. 2 is transformed to a transformed vertex location in the color space;

FIG. 4 is a diagram illustrating a skin sample distribution of a skin group having light skin tones;

FIG. 5 is a diagram illustrating a skin sample distribution of a skin group having medium skin tones;

FIG. 6 is a diagram illustrating a skin sample distribution of a skin group having dark skin tones;

FIG. 7 is a diagram illustrating placement of transformation triangles on a skin sample distribution in order to adjust color of an image and to reduce the yellowish tones of skin;

FIG. 8 is a diagram of a particular illustrative embodiment of a method of color remapping by rotating a color region;

FIG. 9 is a flow chart of a first illustrative embodiment of a method of adjusting color in an image;

FIG. 10 is a flow chart of a second illustrative embodiment of a method of adjusting color in an image;

FIG. 11 is a flow chart of a third illustrative embodiment of a method of adjusting color in an image;

FIG. 12 is a block diagram of a particular illustrative embodiment of a playback apparatus having a skin color adjustment module;

FIG. 13 is a block diagram of a particular illustrative embodiment of an image processing tool having a skin color adjustment module;

FIG. 14 is a block diagram of a portable communication device including a color adjustment module; and

FIG. 15 is a block diagram of particular embodiment of an image sensor device including a color adjustment module.

### V. DETAILED DESCRIPTION

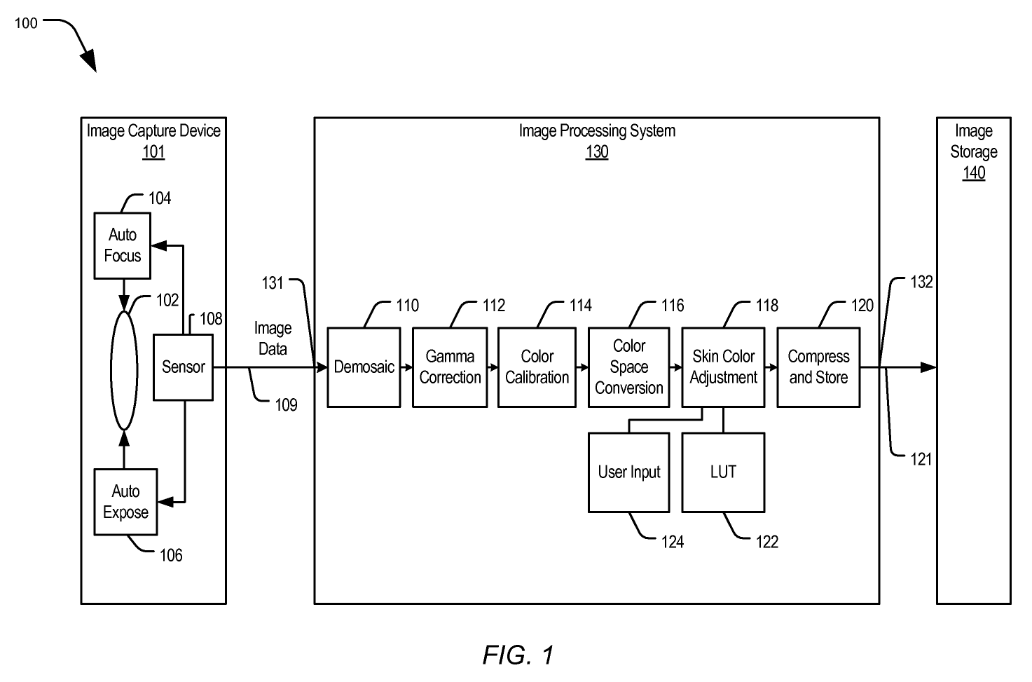

Referring to FIG. 1, a particular illustrative embodiment of a system including an image processing system having a color adjustment module is depicted and generally designated 100. The system 100 includes an image capture device 101 coupled to an image processing system 130. The image processing system 130 is coupled to an image storage device 140. The image processing system 130 is configured to receive image data 109 from the image capture device 101 and to perform a color adjustment operation to adjust color such as skin tone color of an image received via the image data 109. In a particular embodiment, the system 100 is implemented in a portable electronic device configured to perform real-time image processing using relatively limited processing resources.

In a particular embodiment, the image capture device 101 is a camera, such as a video camera or a still camera. The image capture device 101 includes a lens 102 that is responsive to a focusing module 104 and to an exposure module 106. A sensor 108 is coupled to receive light via the lens 102 and to generate the image data 109 in response to an image received via the lens 102. The focusing module 104 may be responsive to the sensor 108 and is adapted to automatically control focusing of the lens 102. The exposure module 106 may also be responsive to the sensor 108 and is adapted to control an exposure of the image. In a particular embodiment, the sensor 108 includes multiple detectors that are arranged so that adjacent detectors detect different colors of light. For example, received light may be filtered so that each detector receives red, green, or blue incoming light.

The image capture device 101 is coupled to provide the image data 109 to an input 131 of the image processing system 130. The image processing system 130 is responsive to the image data 109 and includes a demosaicing module 110. The image processing system 130 also includes a gamma module 112 to generate gamma corrected data from data that is received from the demosaicing module 110. A color calibration module 114 is coupled to perform a calibration on the gamma corrected data. A color space conversion module 116 is coupled to convert an output of the color calibration module 114 to a color space. A skin color adjustment module 118 is coupled to adjust skin color in the color space. The skin color adjustment module 118 may be responsive to a lookup table (LUT) 122 and to a user input 124. A compress and store module 120 is coupled to receive an output of the skin color adjustment module 118 and to store compressed output data 121 to the image storage device 140. An output 132 responsive to the image processing system 130 is adapted to provide output data 121 to the image storage device 140.

The image storage device 140 is coupled to the output 132 and is adapted to store the output data 121. The image storage device 140 may include any type of storage medium, such as one or more display buffers, registers, caches, Flash memory elements, hard disks, any other storage device, or any combination thereof

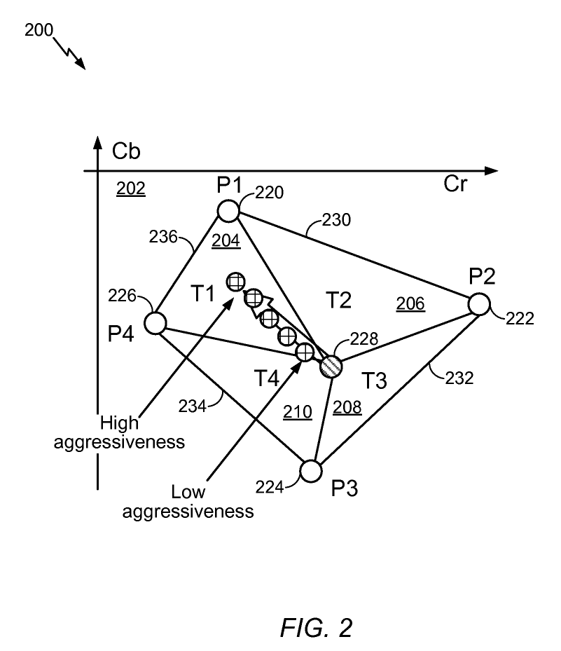

During operation, the skin color adjustment module 118 may efficiently perform color adjustment of the input image data 109. For example, the skin color adjustment module 118 may perform one or more linear transformations within a skin color region of a color space, as described with respect to FIGS. 2-11. In a particular embodiment, the user input 124 may be received via a display interface or other user interface of the system 100 to indicate a user preference of skin color transformation. To illustrate, the user input 124 may indicate a size or shape of the skin color region or an amount or direction of transformation of the skin color region for subsequent images. For example, the user input 124 may indicate a transform of a skin color region to modify a skin color to make a resultant picture or video more pleasing. To illustrate, the user input 124 may designate a transform of a skin color region to reduce an amount of yellow to make skin appear more pale. In another embodiment, the skin color adjustment module 118 may not be responsive to user input and may instead be configured to operate according to predetermined or fixed settings that are not provided by a user.

The skin color adjustment module 118 may receive pixel color data indicating a location of the pixel in a particular color space and may determine whether each pixel of the image data 109 is within a triangular region of the color space corresponding to a skin tone. The skin color adjustment module 118 may be configured to determine whether each pixel is in a triangular region using geometric calculations. For example, the skin color adjustment module 118 may implement an algorithm to traverse the line segments of a perimeter of a triangular region and determine whether a pixel is within the triangular region based on whether the pixel is in a same side of each of the line segments. However, such calculations may be computationally intensive and may be difficult to quickly compute in a real-time image processing system. In the illustrated embodiment, the lookup table 120 stores data indicating color space coordinates that are within each triangular region for an efficient real-time determination of whether a particular pixel corresponds to the skin tone region. The lookup table 120 may also store transformation data for each pixel in the skin tone region. Alternatively, the skin color adjustment module 118 may calculate the transformation of each pixel in the skin tone region based on determining that the pixel is within a particular triangular region. The skin color adjustment may thus be performed automatically during real-time processing of still image data or video data at a video frame rate prior to the image data or the video data being stored at the image storage device 140. Although FIG. 1 illustrates the skin color adjustment module 118 as coupled to the lookup table 120, in other embodiments the image processing system 130 may not include the lookup table 120 and instead the skin color adjustment module 118 perform calculations to determine whether or not each pixel is within a triangular region.

Referring to FIG. 2, a particular illustrative embodiment of a linear transformation that may be performed by the skin color adjustment module 118 of FIG. 1 is depicted and generally designated 200. A first set of triangular regions T1 204, T2 206, T3 208, and T4 210, span a skin tone region of a color space 202. In a particular embodiment, the color space 202 is a Cr-Cb or chroma color space having a red-difference chroma component Cr and a blue-difference chroma component Cb. Triangular region T1 204 is defined by vertices P1 220, P4 226, and a common vertex 228. Triangular region T2 206 is defined by vertices P1 220, P2 222, and the common vertex 228. Triangular region T3 208 is defined by vertices P2 222, P3 224, and the common vertex 228. Triangular region T4 210 is defined by vertices P3 224, P4 226, and the common vertex 228. Each triangular region T1 204, T2 206, T3 208, and T4 210 has a first edge along a boundary of the skin tone region and a vertex 228 at a common point within the skin tone region. For example, the first edge 236 of triangular region T1 204 is defined by vertices P1 220 and P4 226. The first edge 230 of triangular region T2 206 is defined by vertices P1 220 and P2 222. The first edge 232 of triangular region T3 208 is defined by vertices P2 222 and P3 224. The first edge 234 of triangular region T4 210 is defined by vertices P3 224 and P4 226.

During operation, a linear transformation is performed on points within each of the regions T1-T4 204-210 by holding vertices P1 220, P2 222, P3 224, and P4 226 stationary while translating common vertex 228 to a transformed vertex location in the color space 202. In the illustrative example shown in FIG. 2, common vertex 228 is translated in a direction toward the edge boundary 236 and shown at multiple locations along the direction of translation to illustrate a range of “aggressiveness” or amount of transformation. Because the chroma color space represents color information using the red-difference chroma component Cr and the blue-difference chroma component Cb, a linear transformation in the Cr-Cb color space by translating the common vertex 228 also modifies a hue value and a saturation value of the image data. The linear transformation may be performed automatically and may be performed based on user input that includes at least one user specified transformation parameter, such as a hue transformation parameter, a saturation transformation parameter, or both.

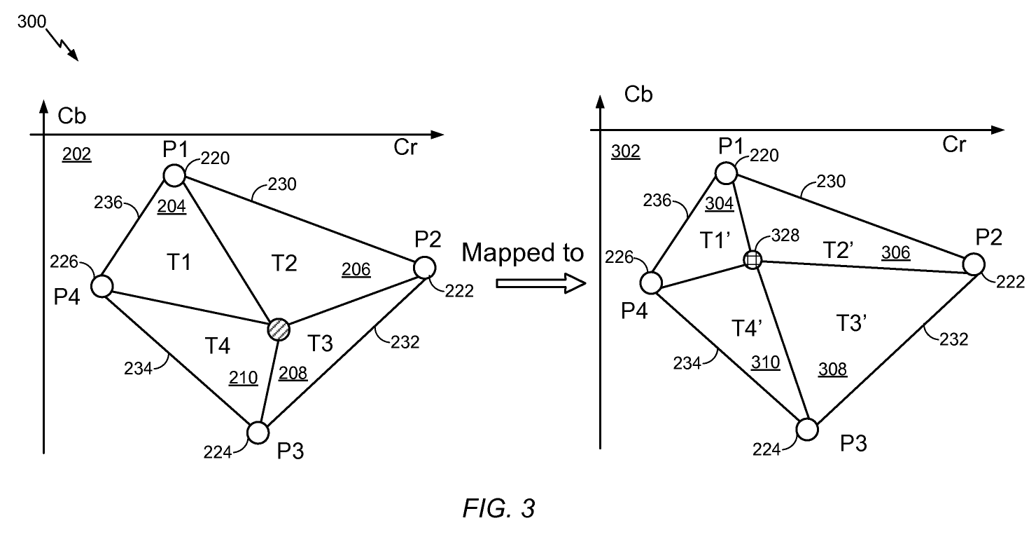

Referring to FIG. 3, a diagram illustrating a linear transformation is depicted and generally designated 300, where the common vertex 228 of the first set of triangular regions of FIG. 2 is transformed to a transformed vertex location 328 in the color space 202. A second set of triangular regions T1′ 304, T2′ 306, T3′ 308, and T4′ 310 span the skin tone region of the color space 302 which represents the transformation of the color space 202. In a particular embodiment, the color space 202 is a chroma color space having a red-difference chroma component Cr and a blue-difference chroma component Cb. Triangular region T1′ 304 is defined by vertices P1 220, P4 226, and common vertex 328. Triangular region T2′ 306 is defined by vertices P1 220, P2 222, and the common vertex 328. Triangular region T3′ 308 is defined by vertices P2 222, P3 224, and the common vertex 328. Triangular region T4′ 310 is defined by vertices P3 224, P4 226, and the common vertex 328. Each triangular region T1′ 304, T2′ 306, T3′ 308, and T4′ 310 has a first edge along a boundary of the skin tone region and a vertex 328 at a common point within the skin tone region. For example, the first edge 236 of triangular region T1′ 304 is defined by vertices P1 220 and P4 226. The first edge 230 of triangular region T2′ 306 is defined by vertices P1 220 and P2 222. The first edge 232 of triangular region T3′ 308 is defined by vertices P2 222 and P3 224. The first edge 234 of triangular region T4′ 310 is defined by vertices P3 224 and P4 226.

As described above with reference to FIG. 2, during operation, a linear transformation is performed by holding vertices P1 220, P2 222, P3 224, and P4 226 stationary while translating the common vertex 228 to a transformed vertex location of the common vertex 328 in the color space 202. In the illustrative example shown in FIG. 3, the common vertex 228 is translated toward the edge boundary 236. A hue value and a saturation value of the image data are modified as a result of translating the common vertex 228. The linear transformation may be performed automatically or may be performed based on user input that includes at least one user specified transformation parameter, such as hue or saturation. In a particular embodiment, the hue value and the saturation value are modified based on a color space transformation of the image data corresponding to the image region having the skin-tone color.

In a particular embodiment, a linear transformation of a location of a pixel in the chroma color space 202 is performed when the location of the pixel is identified as within the skin color region of the color space 202. For each pixel in the original chroma plane, a determination is made whether the particular pixel is located in the color space defined by any of the four triangles. In other words, a determination is made whether the location of the pixel is within one of the first set of triangular regions T1 204, T2 206, T3, 208, or T4 210. If the location of the pixel is identified as within the first set of triangles spanning the skin color region, then the location of the pixel is mapped to a second portion of the color space based on the position of the pixel within the color space and based on a proximity of the position of the pixel to one of the edge boundaries 230, 232, 234, and 236. The transformation is performed according to:

X′=a*X+b*Y+c

Y′=d*X+e*Y+f

X and Y represent first and second coordinate values of a point prior to transformation, and X′ and Y′ represent the first and second coordinate values of the point after transformation. In the embodiment illustrated in FIG. 3, X may correspond to red-difference chroma component Cr and Y may correspond to a blue-difference chroma component Cb in a Cr-Cb color space. The coefficients a, b, c, d, e, and f can be determined for an area enclosed by a particular triangle by entering coordinate data for the vertices of the particular triangle and solving the resulting system of six equations for the six unknown coefficients.

The points outside the skin color region, or outside the boundaries of the triangles 202, 204, 206, and 208 are not translated. The chroma color space 202 remains substantially continuous at the boundary of the skin color region defined by edges 230, 232, 234, and 236 and along the edge of each triangular region T1-T4 after applying the linear transformation. As illustrated, the entire space within each triangular region may be transformed such that an amount of transformation of a particular point depends on a proximity of the point to the first edge of the region, as pixels nearer the boundary of the skin color region are moved less than pixels closer to the common vertex 228. In a particular embodiment, the determination of whether a pixel is located within the skin color region of the color space can be implemented in software, firmware or hardware with a two-dimensional look-up table approach using linear interpolation.

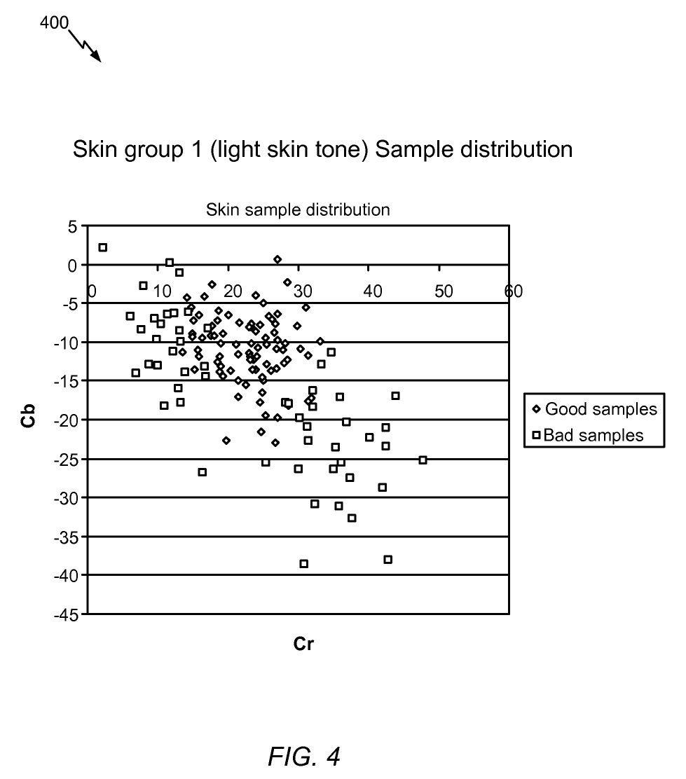

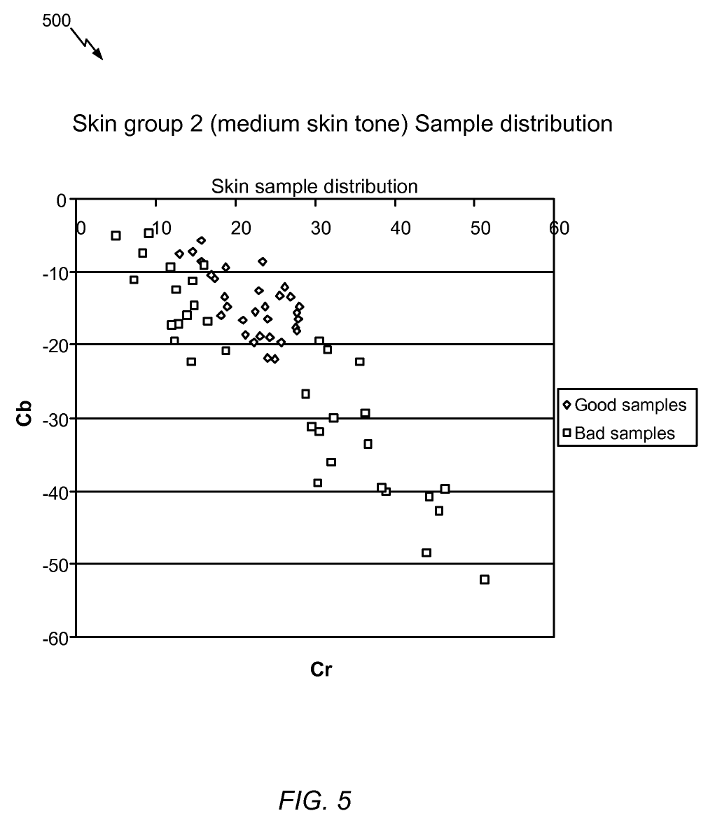

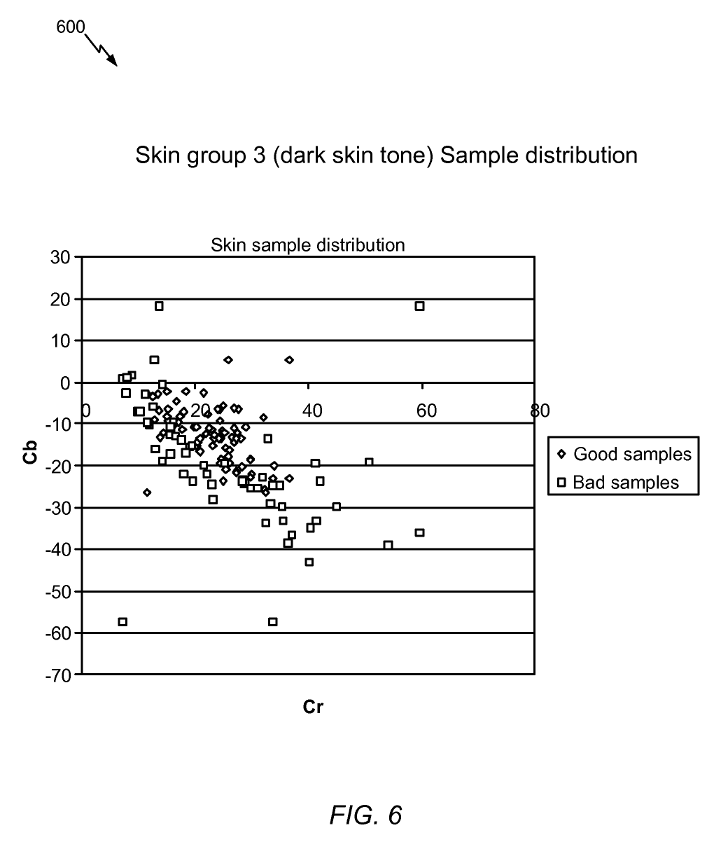

FIG. 4 is a diagram illustrating a skin sample distribution 400 of a skin group having light skin tones. FIG. 5 is a diagram illustrating a skin sample distribution 500 of a skin group having medium skin tones. FIG. 6 is a diagram illustrating a skin sample distribution 600 of a skin group having dark skin tones. In each of the skin sample distributions depicted in FIGS. 4, 5, and 6, it should be noted that “good samples”, or samples that may be visually pleasing, tend to be concentrated in a particular region of the Cr-Cb color space while “bad samples” that may be less pleasing tend to be more distributed throughout the color space. The preference of skin color as illustrated in FIGS. 4-6 is subjective and the illustrated “good samples” and “bad samples” are for illustration purposes only. One way to enhance the skin color is to move the colors in a color space region including the bad samples towards the region of the color space around the good samples.

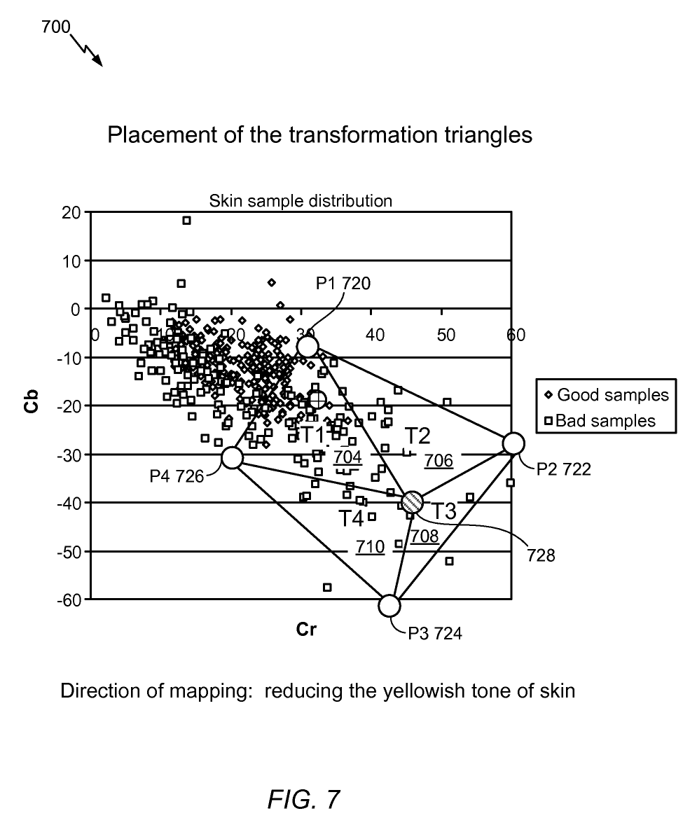

Referring to FIG. 7, a diagram illustrating placement of transformation triangles on a skin sample distribution in order to adjust color of an image and to reduce the yellowish tones of skin is depicted and generally designated 700. By using a two-dimensional linear mapping method, the four vertices P1 720, P2 722, P3 724 and P4 726 remain fixed before and after the linear mapping. Depending on the direction of translation of the common vertex 728, and therefore of the color space within each triangular region T1 704, T2 706, T3 708, and T4 710, the skin color may become paler or tanner. For example, if the common vertex 728 is moved in a direction from triangle T3 708 toward triangle T1 704, the skin color becomes paler. Reversing the direction of movement, the skin color becomes tanner. By translating the common vertex 728, a yellowish tone of skin may be reduced or increased.

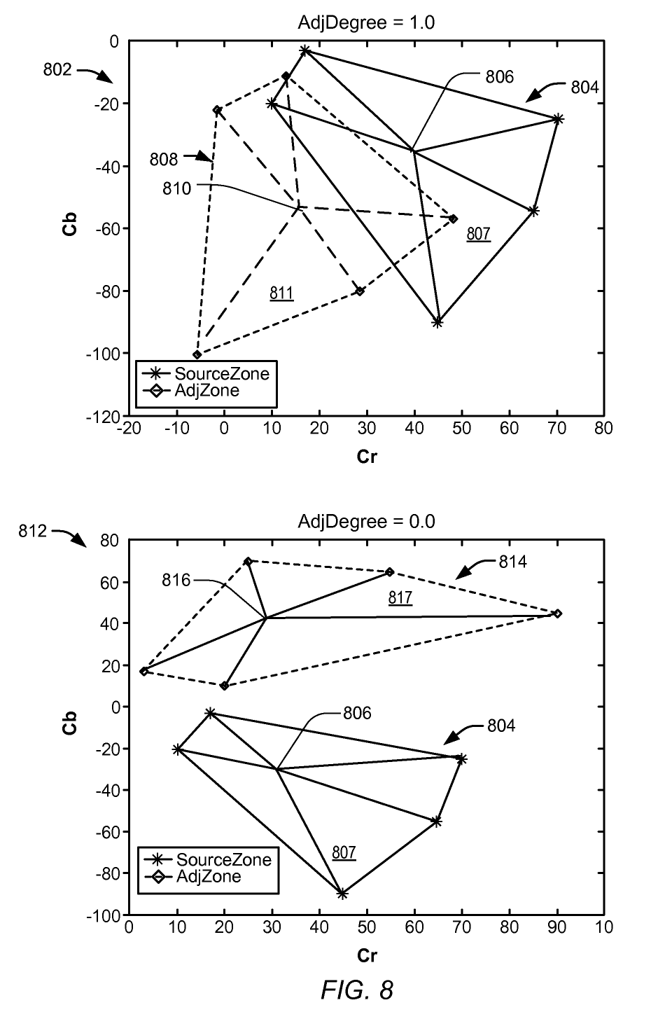

FIG. 8 is a diagram of a particular illustrative embodiment of color remapping by rotating a color region. As illustrated, a first mapping 802 transforms a first region 804 of a color space to a second region 808 of the color space. The first region 804 is spanned by a first set of triangular regions sharing a common vertex 806. The second region 808 is spanned by a second set of triangular regions sharing a common vertex 810. The mapping 802 performs a rotation of approximately −30 degrees to each vertex of the first color region 804 about an origin of the color space to map each triangular region from the first region 804 to the second region 808. As illustrated in FIG. 8, for example, the triangular region 807 is mapped to the triangular region 811 by applying the −30 degree rotation operation to each vertex of the triangular region 807.

A second mapping 812 illustrates a transformation of the first region 804 of the color space to a third region 814 of the color space by performing an approximately 90 degree rotation operation. The third region 814 is spanned by a set of triangular regions sharing a common vertex 816. The mapping 812 performs a rotation of approximately 90 degrees to each vertex of the first color region 804 about an origin of the color space to map each triangular region from the first region 804 to the third region 814. As illustrated in FIG. 8, for example, the triangular region 807 is mapped to the triangular region 817 by applying the 90 degree rotation operation to each vertex of the triangular region 807.

By enabling a transformation of the color space within the region 804 to other regions, such as regions 808 and 814, the mappings 802 and 812 illustrate a versatility of transformation of regions within the color space, but may also introduce discontinuities in the transformed color space that are not introduced in the transformation depicted in FIG. 3. In addition, although FIG. 8 illustrates mapping by applying a rotation operation to each vertex of the region 804, in other embodiments, the vertices may also be translated, rotated, scaled, adjusted, or any combination thereof, as a group or independently of each other, in addition to or in place of the rotation operation. Thus, FIG. 8 illustrates a general color space mapping technique that can be performed in real-time in an image processing pipeline of a portable electronic device, such as the image processing system 130 of FIG. 1. In addition, in a particular embodiment, the color space mappings 802 and 812 illustrated in FIG. 8 need not be applied to skin color regions of the color space and may instead be applied to any user-designated or predetermined region in a general color mapping process.

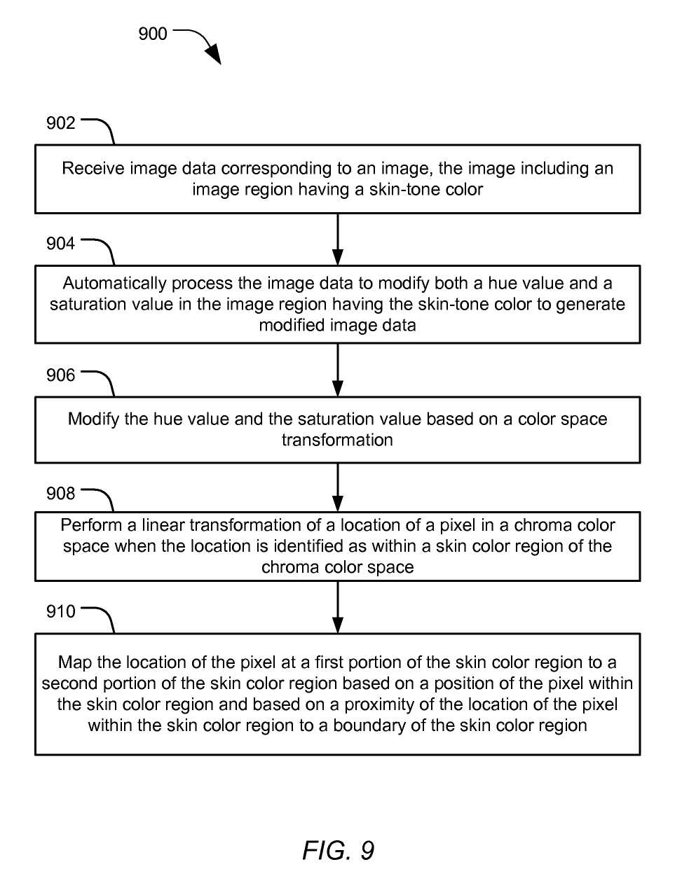

FIG. 9 is a flow diagram of a first particular illustrative embodiment of a method of adjusting color in an image. Generally, the color adjusting method 900 may be performed by one or more of the systems depicted in FIGS. 1 and 12-15, other image processing systems or devices, or any combination thereof At 902, image data corresponding to an image is received. The image includes an image region having a skin-tone color. Advancing to 904, the image data is automatically processed to modify a hue value and a saturation value in the image region having the skin-tone color to generate modified image data that includes a modified hue value and a modified saturation value. In a particular embodiment, at 906, the hue value and the saturation value are modified based on a color space transformation of the image data corresponding to the image region having the skin-tone color. For example, the modified hue value and the modified saturation value may result from a linear transformation that is performed in a chroma color plane, as illustrated in FIG. 3.

Proceeding to 908, a linear transformation of a location of a pixel in a chroma color space may be performed when the location is identified as within a skin color region of the chroma color space. The image data may include color component data representing the location of the pixel in the chroma color space, and the linear transformation may be performed to modify a skin color in the image data. For example, the linear transformation may be performed as described with respect to FIG. 3.

Advancing to 910, the location of the pixel at a first portion of the skin color region of the chroma color space may be mapped to a second portion of the skin color region of the chroma color space based on a position of the pixel within the skin color region and based on a proximity of the position of the pixel to a boundary of the skin color region. For example, as discussed with respect to FIG. 3, a translation of a center vertex of a spanning set of triangular regions results in a transformation of the color space in each triangular region where pixels near the outer edge of the region are translated a lesser amount than pixels in the middle of the region near the center vertex. The chroma color space may remain substantially continuous at the boundary of the skin color region after applying the linear transformation, such as described with respect to FIG. 3, where points on the boundary and outside the skin color region are unaffected by the transformation. In a particular embodiment, the method 900 includes using a set of triangular regions that span the skin-tone region of the chroma color space to transform the pixels within the skin-tone region of the chroma color space in a designated direction, such as illustrated in FIG. 3. The method 900 further includes storing the modified image data in a memory, such as the image storage 140 of FIG. 1.

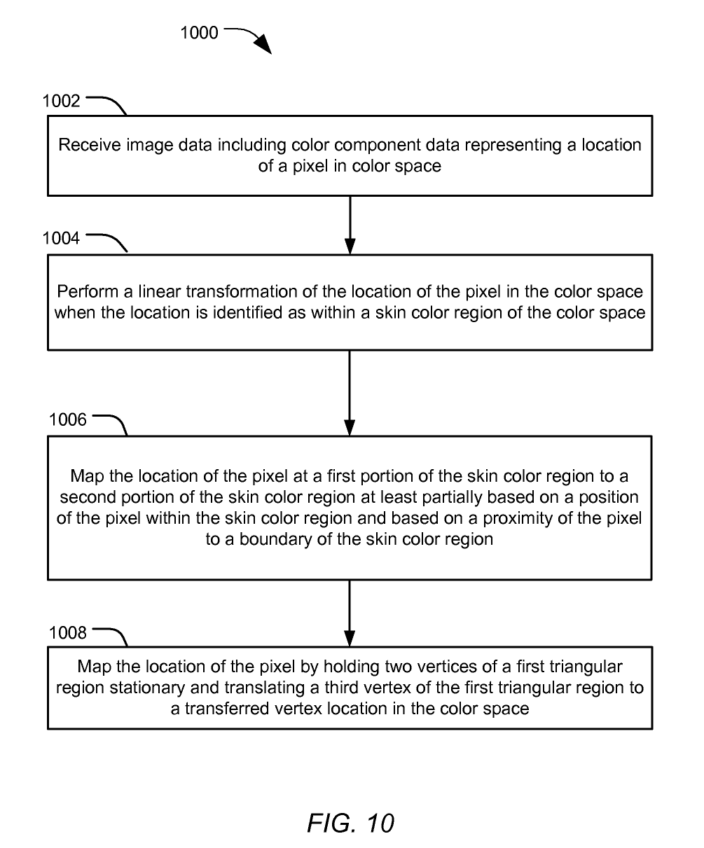

FIG. 10 is a flow diagram of a second particular illustrative embodiment of a method of adjusting color in an image generally designated 1000. Generally, the color adjusting method 1000 may be performed by one or more of the systems depicted in FIGS. 1 and 12-15, other image processing systems or devices, or any combination thereof For example, a portable electronic device having a camera may include a processor readable medium, such as a memory, that stores instructions that are executable by a processor of the portable electronic device to perform the color adjusting method 1000.

At 1002, image data is received including color component data representing a location of a pixel in color space. Continuing to 1004, a linear transformation of the location of the pixel in the color space is performed when the location is identified as within the skin color region of the color space. The linear transformation may be performed to transform a skin color of an image.

In a particular embodiment, for each pixel in the original chroma (Cr-Cb) color plane, a determination is made whether the particular pixel is located in the skin tone region of the color space defined by multiple triangular regions, such as the triangle regions illustrated in FIGS. 2-3. If the particular pixel is determined to be located in the skin tone region of the color space, then a linear transformation may be performed. All pixels within the skin color region (e.g. in a triangle) may move with the linear transformation, while the pixels outside the skin color region are not translated.

Advancing to 1006, the linear transformation is performed by mapping the location of the pixel at a first portion of the skin color region to a second portion of the skin color region at least partially based on a position of the pixel within the skin color region and based on a proximity of the position of the pixel to a boundary of the skin color region. The color space may remain substantially continuous at the boundary of the skin color region after applying the linear transformation.

In a particular embodiment, the method 1000 includes using a first triangular region of a set of triangular regions to transform the pixel within the skin color region in a designated direction, where the set of triangular regions encloses a portion of the skin color region of the color space. Continuing to 1008, the location of the pixel is mapped by holding two vertices of a first triangular region stationary and translating a third vertex of the first triangular region to a transferred vertex location in the color space. For example, the third vertex may be the common vertex 228 of FIG. 3. In a particular embodiment, a hue value and a saturation value of the image data are modified as a result of translating the third vertex. The linear transformation may be performed based on user input that includes at least one user-specified transformation parameter. For example, a user interface may be provided to enable a user to specify the at least one transformation parameter, such as an amount or direction of displacement of the third vertex. Transformed image data including the transformed pixel location may be stored in a memory of an image capture device.

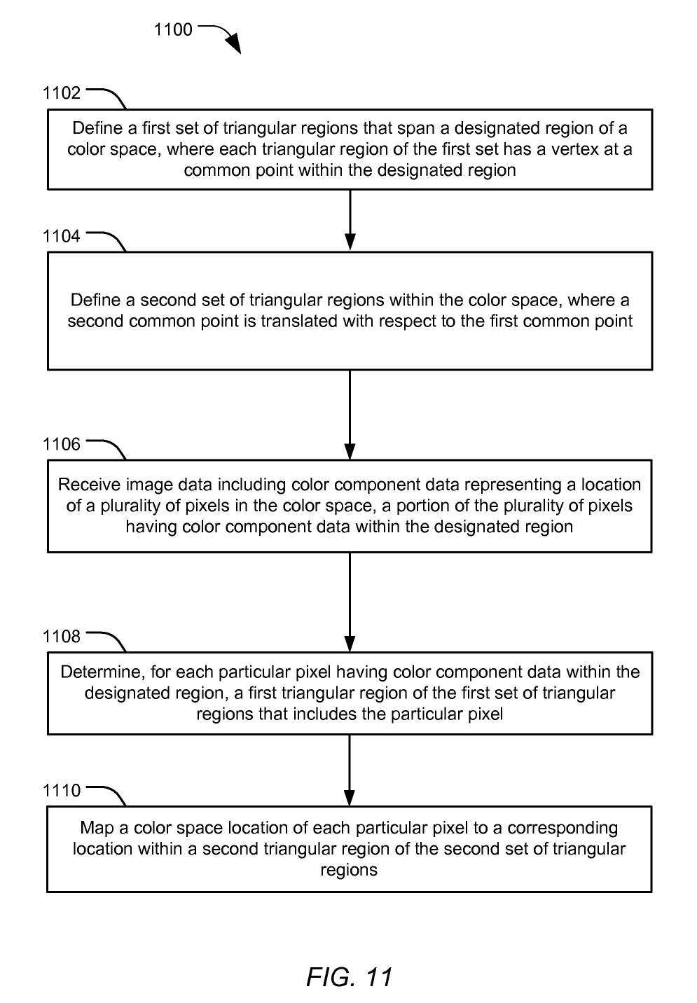

FIG. 11 is a flow diagram of a third particular illustrative embodiment of a method of adjusting color in an image, generally designated 1100. Generally, the color adjusting method may be performed by one or more of the systems depicted in FIGS. 1 and 12-15, other image processing systems or devices, or any combination thereof. At 1102, a first set of triangular regions that spans a designated region of a color space is defined, where each triangular region of the first set has a vertex at a common point within the designated region. Continuing to 1104, a second set of triangular regions within the color space is defined. Each triangular region within the second set of triangular regions has a vertex at a second common point. The second common point is translated with respect to the first common point. Continuing to 1106, image data is received including color component data representing a location of a plurality of pixels in the color space. Some of the plurality of pixels have color component data within the designated region. Advancing to 1108, for each particular pixel having color component data within the designated region, a first triangular region of the first set of triangular regions that includes the particular pixel is determined. Continuing to 1110, a color space location of each particular pixel is mapped to a corresponding location within a second triangular region of the second set of triangular regions.

In a particular embodiment, the designated region is a skin-tone region, the second set of triangular regions spans the designated skin-tone region, and each triangular region of the second set has a first edge along the boundary of the skin tone region, such as illustrated in FIG. 3. In another embodiment, the designated region need not be a skin-tone region and need not span the same region as the designated region, such as illustrated in FIG. 8.

In a particular embodiment, the second triangular region represents a transformation of the first triangular region, and the mapping is performed according to the transformation of the first triangular region. The transformation may include a linear transformation based on user input that includes at least one user-specified transformation parameter, such as a hue value or a saturation value. A user interface may be provided to enable a user to specify the at least one user-specified transformation parameter.

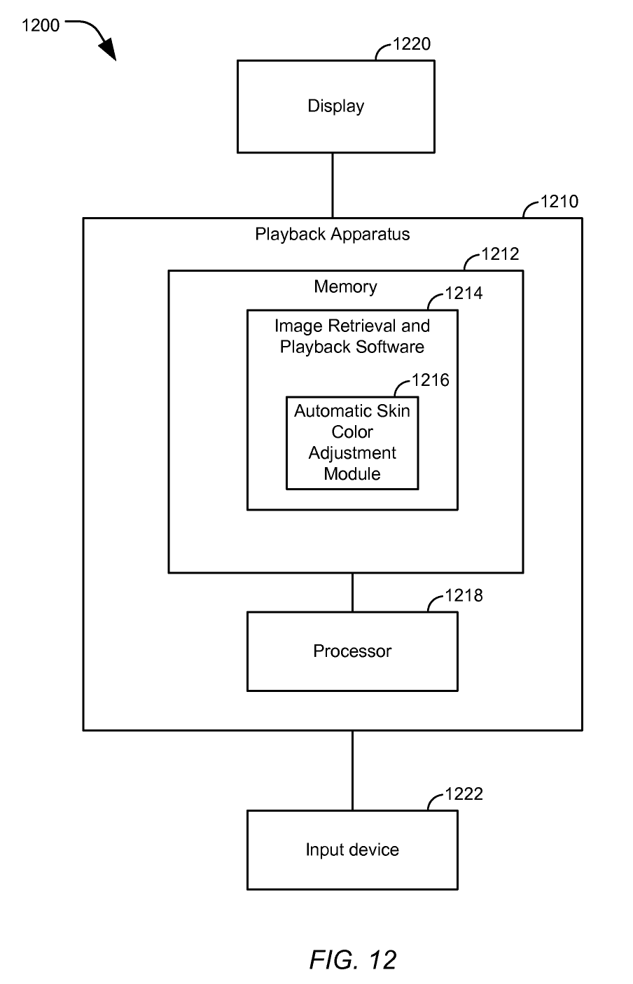

Referring to FIG. 12, a particular illustrative embodiment of a system including a playback apparatus having a skin color adjustment module is depicted and generally designated 1200. The system 1200 includes a display 1220 coupled to a playback apparatus 1210. The playback apparatus 1210 includes a memory 1212 that is accessible to a processor 1218. The memory 1212 is illustrated as including image retrieval and playback software 1214 which includes a skin color adjustment module 1216. An input device 1222 is coupled to the playback apparatus 1210.

The processor 1218 may be a general processor, a digital signal processor (DSP), or an image processor, coupled to the memory 1212 and also coupled to the skin color adjustment module 1216 illustrated within the memory 1212. In an illustrative example, the skin color adjustment module 1216 may be executable using program instructions that are stored in the memory 1212 and that are executable by the processor 1218. For example, playback apparatus 1210 may include a computer and the skin color adjustment module 1216 may be a computer program stored on computer readable media having instructions to cause the computer to adjust color of an image. In other embodiments, the skin color adjustment module 1216 may be implemented in hardware, firmware, or any combination thereof, and may operate in accordance with one or more of the embodiments depicted in FIGS. 2-11.

For example, the skin color adjustment module 1216 may include instructions executable to cause the playback apparatus 1210 to receive image data including color component data representing a pixel value in a chroma color space and to perform a linear transformation of a pixel associated with the pixel value when a location of the pixel is identified as within a skin color region of the chroma color space. The linear transformation may be performed by mapping the location of the pixel at a first portion of the skin color region to a second portion of the skin color region based on a position of the pixel within the skin color region and based on a proximity of the position of the pixel to a boundary of the skin color region, as described with respect to FIG. 3.

The skin color adjustment module 1216 may be executable to cause the playback apparatus 1210 to determine that the pixel is within a predetermined region of the chroma color space. The predetermined region may be a first triangular region of a set of triangular regions that substantially enclose a portion of the skin color region of the chroma color space. For example, the set of triangular regions may completely span the skin color region of the chroma color space. The playback apparatus 1210 may cause two vertices of the first triangular region to remain stationary and translate the third vertex based on a skin color hue transformation setting and based on a skin color saturation transformation setting that identifies the skin color region of the chroma color space. The transformed image data including the transformed pixel value may be stored at the memory 1212.

In a particular embodiment, the input device 1222, the display 1220, or both, provide a user interface that enables a user of the system 1200 to input one or more user-specified transformation parameters. For example, the input device 1222 may include means for enabling a user to specify the at least one transformation parameter, such as a keyboard, a pointing device, such as a mouse, joystick, or trackball, a touchscreen, a microphone, a speech recognition device, a remote control device, or any other apparatus to provide transformation data to the playback apparatus 1210 or any combination thereof. The transformation data provided by the user may include a selection of one or more points of a boundary of a skin-tone region, the center vertex of a set of triangular regions spanning the skin-tone region, a transformation location or vector indicating a mapping of the center vertex to another location, other transformation data, or any combination thereof. For example, the means for enabling a user to specify the at least one transformation parameter may enable a user to select vertices of the boundary of a region of the color space by navigating a cursor displayed in a representation of the color space at the display device 1220, to select a starting point of the center vertex, and to drag the center vertex to a new position. In a particular embodiment, an effect of the transformation may be provided to the user by displaying an image at the display 1220 having a color that is transformed in response to the user input.

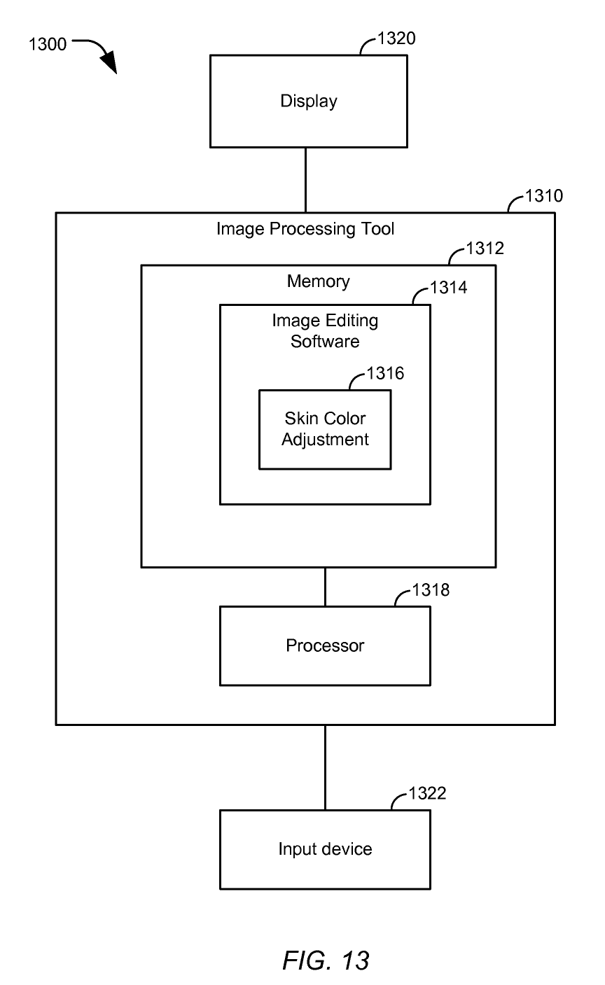

Referring to FIG. 13, a particular illustrative embodiment of a system including an image processing tool including a skin color adjustment module is depicted and generally designated 1300. The system 1300 includes a display 1320 coupled to an image processing tool 1310. The image processing tool 1310 includes a memory 1312. The memory 1312 includes image editing software 1314 and is further illustrated as including a skin color adjustment module 1316. An input device 1322 is coupled to the image processing tool 1310. The image processing tool 1310 includes a processor 1318, such as a general processor, a digital signal processor (DSP), or an image processor, coupled to the memory 1312 and the skin color adjustment module 1316. In an illustrative example, the skin color adjustment module 1316 is executable using program instructions that are stored in the memory 1312 and that are executable by the processor 1318.

For example, image processing tool 1310 may be a computer and the skin color adjustment module 1316 may be a computer program stored on computer readable media having instructions to cause the computer to adjust color of an image. In other embodiments, the skin color adjustment module 1316 may be implemented in hardware, firmware, or any combination thereof, and may operate in accordance with one or more of the embodiments depicted in FIGS. 2-12.

In a particular embodiment, the input device 1322, the display 1320, or a combination of both, provides a user interface that enables a user of the system 1300 to enter one or more user-specified transformation parameters. For example, the input device 1322 may include means for enabling a user to specify the at least one transformation parameter, such as a keyboard, a pointing device, such as a mouse, joystick, or trackball, a touchscreen, a microphone, a speech recognition device, a remote control device, or any other apparatus to provide transformation data to the image processing tool 1310, or any combination thereof. The transformation data provided by the user may include a selection of one or more points of a boundary of a skin-tone region, the center vertex of a set of triangular regions spanning the skin-tone region, a transformation location or vector indicating a mapping of the center vertex to another location, other transformation data, or any combination thereof. For example, the means for enabling a user to specify the at least one transformation parameter may enable a user to select vertices of the boundary of a region of the color space by navigating a cursor displayed in a representation of the color space at the display device 1320, to select a starting point of the center vertex, and to drag the center vertex to a new position. In a particular embodiment, an effect of the transformation may be provided to the user by displaying an image at the display 1320 having a color that is transformed in response to the user input.

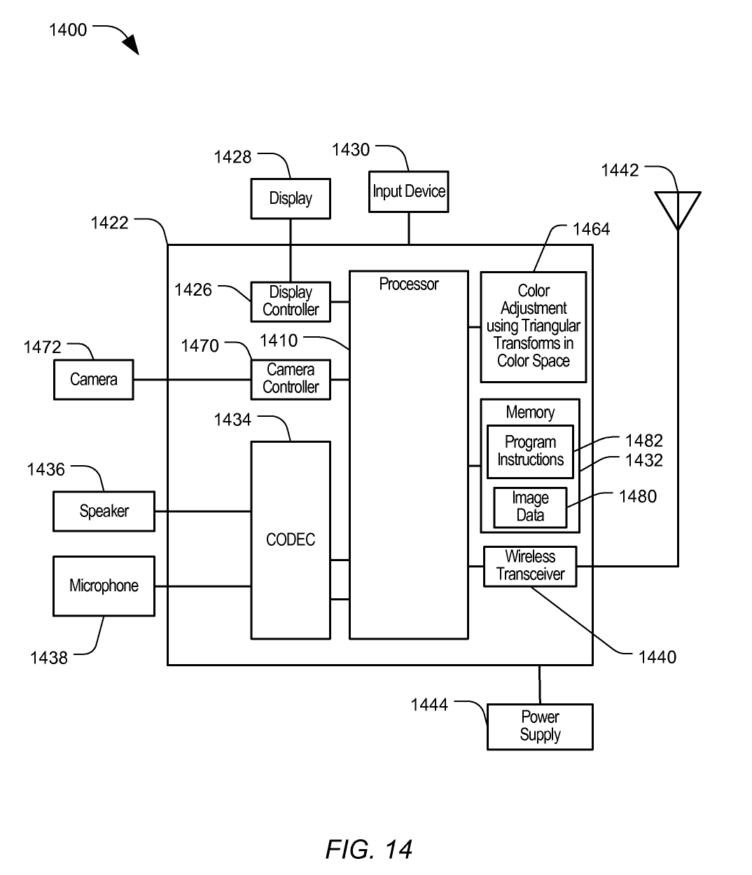

Referring to FIG. 14, a particular illustrative embodiment of a wireless communication device including a skin color adjustment module is depicted and generally designated 1400. The device 1400 includes a processor 1410, such as a general processor, a digital signal processor (DSP), or an image processor, coupled to a memory 1432 and also coupled to a color adjustment module using triangular transforms in color space 1464. In an illustrative example, the color adjustment module 1464 is executable using program instructions 1482 that are stored in the memory 1432 and that are executable by the processor 1410. In other embodiments, the skin color adjustment module 1464 may be implemented in hardware, firmware, or any combination thereof, and may include one or more systems or modules depicted in FIGS. 1 and 12-13 or may operate in accordance with one or more of the embodiments depicted in FIGS. 2-11.

A camera 1472 is coupled to the processor 1410 via a camera controller 1470. The camera 1472 may include a still camera, a video camera, or any combination thereof The camera controller 1470 is adapted to control an operation of the camera 1472, including storing captured and processed image data 1480 at the memory 1432.

FIG. 14 also shows a display controller 1426 that is coupled to the processor 1410 and to a display 1428. A coder/decoder (CODEC) 1434 can also be coupled to the processor 1410. A speaker 1436 and a microphone 1438 can be coupled to the CODEC 1434.

FIG. 14 also indicates that a wireless transceiver 1440 can be coupled to the processor 1410 and to a wireless antenna 1442. In a particular embodiment, the processor 1410, the display controller 1426, the memory 1432, the CODEC 1434, the wireless transceiver 1440, the camera controller 1470, and the skin color adjustment module 1464 are included in a system-in-package or system-on-chip device 1422. In a particular embodiment, an input device 1430 and a power supply 1444 are coupled to the system-on-chip device 1422. Moreover, in a particular embodiment, as illustrated in FIG. 14, the display 1428, the input device 1430, the speaker 1436, the microphone 1438, the wireless antenna 1442, the camera 1472, and the power supply 1444 are external to the system-on-chip device 1422. However, each of the display 1428, the input device 1430, the speaker 1436, the microphone 1438, the wireless antenna 1442, the camera 1472, and the power supply 1444 can be coupled to a component of the system-on-chip device 1422, such as an interface or a controller.

The system 1400 includes means for enabling a user to specify at least one transformation parameter to be used by the skin color adjustment module 1464, such as the display 1428, the input device 1430, or both. For example, the display controller 1426 may be configured to provide a graphical user interface at the display 1428 having interface elements that are navigable and selectable via the input device 1430. The means for enabling a user to specify at least one transformation parameter to be used by the skin color adjustment module 1464 may include a keyboard, one or more physical keys, buttons, switches, and the like, a touchscreen surface at the display 1428, a joystick, mouse, or a directional controller. In addition or alternatively, the means for enabling a user to specify at least one transformation parameter to be used by the skin color adjustment module 1464 may include one or more sensors to detect a physical property of the system 1400 such as an inclinometer, accelerometer, local or global positioning sensor, or other physical sensor, or other navigation device, or any combination thereof, either physically attached to the system 1400 or wirelessly coupled to the system, such as at a remote control device in communication with the system 1400 via a wireless signal network, such as via an ad-hoc short range wireless network.

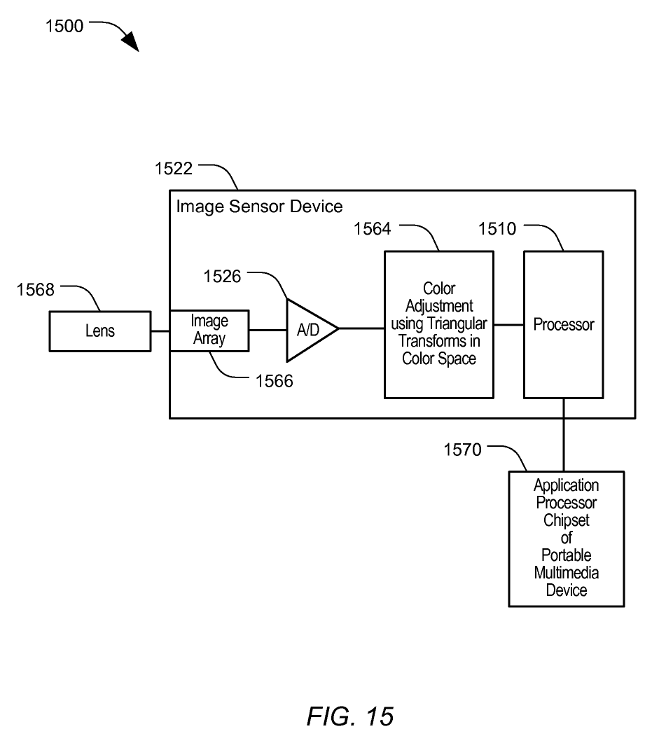

FIG. 15 is a block diagram of a particular embodiment of a system including a color adjustment module using triangular transforms in color space. The system 1500 includes an image sensor device 1522 that is coupled to a lens 1568 and that is also coupled to an application processor chipset of a portable multimedia device 1570. The image sensor device 1522 includes a color adjustment using triangular transforms in color space module 1564 to adjust color in image data prior to providing the image data to the application processor chipset 1570 by performing translations of a region of color space that is spanned by a set of triangles, such as by implementing one or more of the systems of FIGS. 1 and 12-15, by operating in accordance with any of the embodiments of FIGS. 2-11, or any combination thereof

The color adjustment module using triangular transforms in color space 1564 is coupled to receive image data from an image array 1566, such as via an analog-to-digital convertor 1526 that is coupled to receive an output of the image array 1566 and to provide the image data to the color adjustment using triangular transforms in color space module 1564.

The color adjustment using triangular transforms in color space module 1564 may be adapted to determine whether each particular pixel of the image data is within a triangular region of a color space to be transformed. For example, the color adjustment module 1564 may be adapted to perform a transform of red, green, and blue (RGB) pixel color data to luma and chroma (YCrCb) data, and to determine whether the CrCb data is within a predetermined triangular region of the Cr-Cb color plane. The color adjustment module 1564 may be configured to perform a linear transformation of the pixel according to a linear transformation of the triangular region, such as described with respect to FIG. 3. The color adjustment module 1564 may be configured to perform a general transformation, such as via a rotation operation, as depicted in FIG. 8.

In a particular embodiment, the color adjustment module 1564 can include one or more lookup tables (not shown) storing pixel information to reduce an amount of computation to determine whether or not each pixel is within a triangular region. The triangular regions and transformations may be predetermined, such as based on a skin-tone region of the Cr-Cb color space. For example, the color adjustment module 1564 may be set to enhance skin tones based on a population preference. To illustrate, when the image sensor device 1522 is sold or distributed in east Asia, the color adjustment module 1564 may be configured to reduce an amount of yellow in skin, while in other regions the color adjustment module 1564 may be configured to enhance skin colors to make resulting pictures more pleasing to the population of the particular region. In a particular embodiment, the transformation may be performed according to one or more user input parameters, such as may be provided via a user interface of a portable multimedia device.

The image sensor device 1522 may also include a processor 1510. In a particular embodiment, the processor 1510 is configured to implement the color adjustment using triangular transforms in color space module 1564 functionality. In another embodiment, the color adjustment using triangular transforms in color space module 1564 is implemented as separate image processing circuitry.

The processor 1510 may also be configured to perform additional image processing operations, such as one or more of the operations performed by the modules 112-120 of FIG. 1. The processor 1510 may provide processed image data to the application processor chipset 1570 for further processing, transmission, storage, display, or any combination thereof.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

1. A method to adjust color in an image, the method comprising:
receiving image data corresponding to an image, the image comprising an image region having a skin-tone color;
automatically processing the image data to modify a hue value and a saturation value in the image region having the skin-tone color to generate modified image data that includes a modified hue value and a modified saturation value; and
storing the modified image data in a memory.

2. The method of claim 1, wherein the hue value and the saturation value are modified based on a color space transformation of the image data corresponding to the image region having the skin-tone color.

3. The method of claim 2, further comprising performing a linear transformation of a location of a pixel in a chroma color space when the location is identified as within a skin color region of the chroma color space, wherein the image data includes color component data representing the location of the pixel in the chroma color space, and wherein the linear transformation is performed to modify a skin color in the image data.

4. The method of claim 3, further comprising mapping the location of the pixel at a first portion of the skin color region of the chroma color space to a second portion of the skin color region of the chroma color space based on a position of the pixel within the skin color region and based on a proximity of the position of the pixel to a boundary of the skin color region, wherein the chroma color space remains substantially continuous at the boundary of the skin color region after applying the linear transformation.

5. The method of claim 4, further comprising using a set of triangular regions that spans the skin-tone region of the chroma color space to transform the pixel within the skin-tone region of the chroma color space in a designated direction.

6. A method to adjust color in an image, the method comprising:
receiving image data including color component data representing a location of a pixel in a color space; and
performing a linear transformation of the location of the pixel in the color space when the location is identified as within a skin color region of the color space, wherein the linear transformation is performed by mapping the location of the pixel at a first portion of the skin color region to a second portion of the skin color region based on a position of the pixel within the skin color region and based on a proximity of the position of the pixel to a boundary of the skin color region, wherein the color space remains substantially continuous at the boundary of the skin color region after applying the linear transformation.

7. The method of claim 6, further comprising using a first triangular region of a set of triangular regions to transform the pixel within the skin color region in a designated direction, wherein the set of triangular regions encloses a portion of the skin color region of the color space.

8. The method of claim 7, further comprising mapping the location of the pixel by holding two vertices of the first triangular region stationary and translating a third vertex of the first triangular region to a transformed vertex location in the color space.

9. The method of claim 8, further comprising modifying a hue value and a saturation value of the image data as a result of translating the third vertex.

10. The method of claim 6, further comprising storing transformed image data including a transformed pixel location in a memory of an image capture device.

11. The method of claim 6, wherein the linear transformation is performed based on user input that includes at least one user-specified transformation parameter.

12. The method of claim 11, further comprising providing a user interface to enable a user to specify the at least one transformation parameter.

13. The method of claim 6, wherein the linear transformation is performed to transform a skin color of an image.

14. A method to adjust color in an image, the method comprising:
defining a first set of triangular regions that spans a designated region of a color space, wherein each triangular region of the first set of triangular regions has a first edge along a boundary of the designated region and a vertex at a common point within the designated region;
defining a second set of triangular regions within the color space, each triangular region of the second set of triangular regions having a vertex at a second common point, wherein the second common point is translated with respect to the first common point;
receiving image data including color component data representing a location of a plurality of pixels in the color space, some of the plurality of pixels having color component data within the designated region;
determining, for each particular pixel having color component data within the designated region, a first triangular region of the first set of triangular regions that includes the particular pixel; and
mapping a color space location of each particular pixel to a corresponding location within a second triangular region of the second set of triangular regions.

15. The method of claim 14, wherein the designated region is a skin-tone region, wherein each triangular region of the second set of triangular regions has a first edge along the boundary of the skin-tone region, wherein the second triangular region represents a transformation of the first triangular region, and wherein the mapping is performed according to the transformation of the first triangular region.

16. The method of claim 15, wherein the transformation includes a linear transformation based on user input that includes at least one user-specified transformation parameter.

17. A computer program stored on computer readable media to adjust color of an image, the computer program having instructions that are executable to cause the computer to:
receive image data including color component data representing a pixel value in a chroma color space; and
perform a linear transformation of a pixel associated with the pixel value when a location of the pixel is identified as within a skin color region of the chroma color space, wherein the linear transformation is performed by mapping the location of the pixel at a first portion of the skin color region to a second portion of the skin color region based on a position of the pixel within the skin color region and based on a proximity of the position of the pixel to a boundary of the skin color region, wherein the chroma color space remains substantially continuous at the boundary of the skin color region after applying the linear transformation.

18. The computer program of claim 17, further comprising instructions that are executable by the computer to determine whether the pixel is within a predetermined region of the chroma color space, wherein the predetermined region is a first triangular region of a set of triangular regions substantially enclosing a portion of the skin color region of the chroma color space.

19. The computer program of claim 18, further comprising instructions that are executable by the computer to map the pixel to a transformed pixel location of the chroma color space, wherein the linear transformation includes at least two vertices of the first triangular region remaining stationary and translating a third vertex to a transformed vertex location in the chroma color space.

20. The computer program of claim 19, further comprising instructions that are executable by the computer to:
translate the third vertex based on a skin color hue transformation setting and based on a skin color saturation transformation setting that identifies the skin color region of the chroma color space, and wherein the skin color region of the chroma color space is spanned by the set of triangular regions; and
store transformed image data including the transformed pixel value.

21. An apparatus, comprising:
an input to receive image data including color component data representing a location of a pixel in a chroma color space; and
an image processing path coupled to the input, the image processing path including skin color adjustment circuitry configured to generate modified image data by performing a color space mapping of skin tones of an image to appear less yellow.

22. The apparatus of claim 21, further comprising a memory configured to store the modified image data prior to displaying the modified image data at a display device.

23. The apparatus of claim 21, wherein the skin color adjustment circuitry is further configured to perform a linear transformation of the pixel when the location of the pixel is identified as within a skin color region of the chroma color space, wherein the linear transformation is performed by mapping the location of the pixel at a first portion of the skin color region to a second portion of the skin color region based on a position of the pixel within the skin color region and based on a proximity of the position of the pixel to a boundary of the skin color region.

24. The apparatus of claim 23, further comprising an image capture device coupled to the input and configured to generate the image data.

25. The apparatus of claim 21, wherein the skin color adjustment circuitry is further configured to perform the linear transformation based on user input that includes at least one user-specified transformation parameter.

26. The apparatus of claim 25, further comprising means for enabling a user to specify the at least one transformation parameter.

27. An apparatus, comprising:
means for receiving image data including color component data representing a location of a pixel in a chroma color space; and
means for generating modified image data by performing a color space mapping of skin tones of an image to appear less yellow.

28. The apparatus of claim 27, further comprising means for performing a linear transformation of the location of the pixel in the chroma color space when the location is identified as within a skin color region of the chroma color space.

29. The apparatus of claim 28, further comprising means for mapping the location of the pixel at a first portion of the skin color region to a second portion of the skin color region based on a position of the pixel within the skin color region and based on a proximity of the position of the pixel to a boundary of the skin color region, wherein the chroma color space remains substantially continuous at the boundary of the skin color region after applying the linear transformation.
